(19) United States
(12) Patent Application Publication
(10) Pub. No.: US 2008/0277908 A1
(43) Pub. Date: Nov. 13, 2008

(54) MOLDED STEERING WHEEL

(76) Inventors: Danielle L. White, Macomb, IL (US); Michael J. Olesko, Ann Arbor, MI (US); Dennis A. Burton, Fenton, MI (US); Scott C. Purks, North Branch, MI (US); Eric J. Jaarda, Milan, MI (US); Manish Chaturvedi, Bangalore (IN)

Correspondence Address: CARLSON, GASKEY & OLDS, P.C., 400 WEST MAPLE ROAD, SUITE 350, BIRMINGHAM, MI, 48009, US

(21) Appl. No.: 12/118,177

(22) Filed: May 9, 2008

Related U.S. Application Data
(60) Provisional application No. 60/928,475, filed on May 9, 2007.

(51) Int. Cl. B60R 21/203; B62D 1/04

(52) U.S. Cl. 280/731; 74/552; 156/245

(57) ABSTRACT

An example steering wheel assembly includes an airbag module receiving surface generally defining a first plane. A lower portion includes a lower rim portion and the airbag module receiving surface. An upper portion includes an upper rim portion for covering the lower rim portion. The upper portion and the lower portion define a second plane spaced from said first plane.

This application claims priority to U.S. Provisional Application No. 60/928,475, which was filed on May 9, 2007.

### BACKGROUND OF THE INVENTION

This invention relates generally to a molded steering wheel assembly.

Steering wheels for vehicles are well known. Some steering wheels include a circular rim connected by spokes to a central hub. Moving the rim turns the spokes and the central hub, which coveys torque to the vehicle's steering system. The steering wheel may include an airbag module mounting location near the central hub of the steering wheel.

Typical steering wheels maintain performance requirements, such as meeting certain strength requirements. Such requirements help ensure performance of the steering wheel under various conditions. As an example, some requirements are directed toward maintaining steering control over the vehicle under a wide range of events. Other requirements relate to the allowable deflection or bend when loaded.

Many steering wheels, especially molded steering wheels, require a support structure of a dissimilar material within the rim to meet the performance standards. Accordingly, some steering wheels overmold a cast metal armature with polyurethane to form the rim. The armature provides support and resists deflection, but undesirably increases the weight, cost, and complexity of the steering wheel. The step of overmolding the cast metal armature also complicates the assembly process. Other steering wheel support structures strengthen the airbag module mounting location for example.

### SUMMARY OF THE INVENTION

An example steering wheel assembly includes an airbag module receiving surface generally defining a first plane. A lower portion includes a lower rim portion and the airbag module receiving surface. An upper portion includes an upper rim portion for covering the lower rim portion. The upper rim portion and the lower rim portion define a second plane spaced from said first plane where the upper rim portion contacts the lower rim portion. The lower portion may include an overmolded hub plate.

The steering wheel assembly may include an upper rim portion and a lower rim portion. An upper spoke portion secures to the upper rim portion, and a lower spoke portion secures to the lower rim portion. An airbag module mounting surface and the upper spoke portion define an airbag module receiving space.

An example method of assembling a steering wheel includes molding an upper rim portion together with an upper spoke portion and molding a lower rim portion together with a lower spoke portion and an airbag module mounting surface. The method also includes welding the upper rim portion to the lower rim portion.

### BRIEF DESCRIPTION OF THE DRAWINGS

These and other features of the present invention can be best understood from the following specification and drawings, the following of which is a brief description.

FIG. 1 illustrates an exploded view an example steering wheel assembly.

FIG. 2 illustrates a top view of the FIG. 1 assembly.

FIG. 3 illustrates a sectional view taken along Line 3-3 of FIG. 2.

FIG. 4 illustrates a perspective view of the hub and hub plate of FIG. 1.

FIG. 5 illustrates a bottom view of the FIG. 1 assembly.

FIG. 6 illustrates a rear view of the upper portion of the FIG. 1 assembly.

### DETAILED DESCRIPTION OF THE PREFERRED EMBODIMENT

The present invention is more particularly described in the following description and examples that are intended to be illustrative only since numerous modifications and variations therein will be apparent to those skilled in the art. As used in the specification and in the claims, the term “comprising” may include the embodiments “consisting of” and “consisting essentially of.” All ranges disclosed herein are inclusive of the endpoints and are independently combinable. The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. In at least some instances, the approximating language may correspond to the precision of an instrument for measuring the value.

The present invention provides a steering wheel assembly that includes an airbag module. The airbag module includes a receiving surface generally defining a first plane. A lower portion includes a lower rim portion and the airbag module receiving surface. An upper portion includes an upper rim portion for covering the lower rim portion. The upper rim portion and the lower rim portion define a second plane spaced from said first plane where the upper rim portion contacts the lower rim portion. The lower portion may include an overmolded hub plate.

An example steering wheel assembly 10 includes an upper portion 14 and a lower portion 18. A driver airbag module 22 secures within an airbag module mounting space 26 defined by the upper portion 14 and the lower portion 18. A plurality of lower spokes 30 connect the airbag module mounting space 26 to a lower rim 34. A plurality of upper spokes 38 connect to an upper rim 42. The upper portion 14 and the lower portion 18 are injection molded of a high-strength thermoplastic material. A suitable thermoplastic material is deformable and absorbs energy during an impact event. Specifically, a suitable thermoplastic material has the properties of elastic deformation at low loads and plastic deformation at high loads. Low loads being characterized as those encountered during normal operation of a steering wheel, and high loads being characterized as severe abuse or impact events as defined under Federal Motor Vehicle Safety Standard 203. Further, in one embodiment, the thermoplastic material has a 20 percent stress to failure rating as measured by tensile testing in accordance with ASTM D-638. Examples of suitable thermoplastic materials include, but are not limited to, silicone modified polycarbonate, nylon, polyesters, polyphenylene oxide, polypropylene, mixtures thereof, and foamed materials thereof. In the exemplary embodiment, silicone modified polycarbonate, commercially available from SABIC Innovative Plastics under the trademark LEXAN® EXL, is used. The upper portion 14 and lower portion 18 are generally aligned relative a rotational axis extending through a vehicular steering column (not shown).

The airbag module mounting space 26 provides clearance for mounting an airbag module or similar safety accessory within the steering wheel assembly 10. The airbag module 22 mounts within the airbag module mounting space 26 adjacent a pair of airbag module receiving surfaces 28 that define a first plane generally transverse the rotational axis.

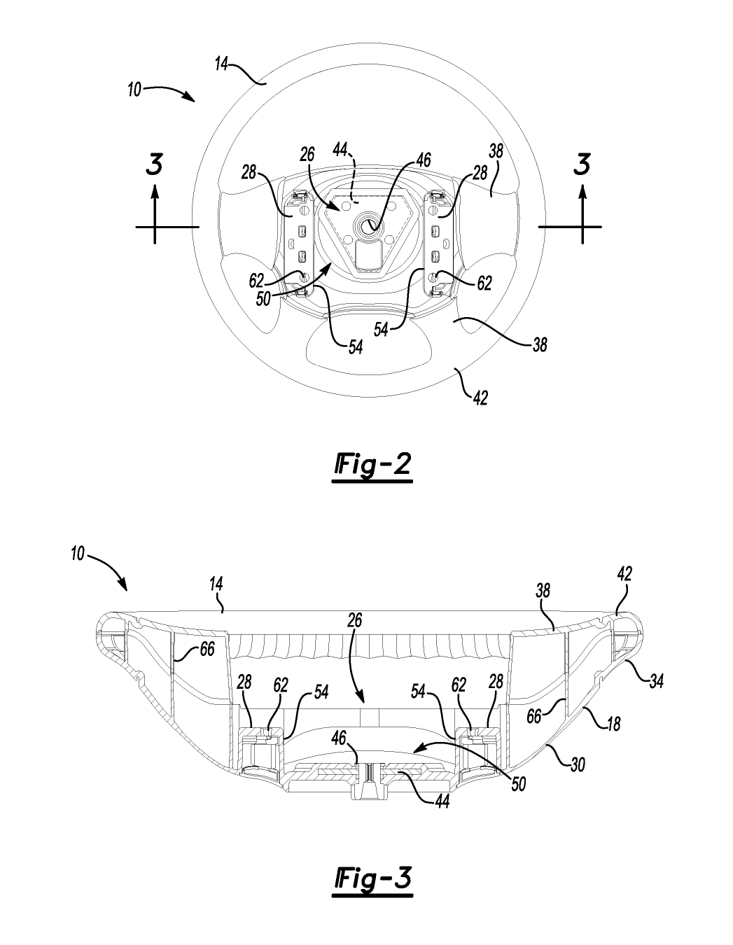

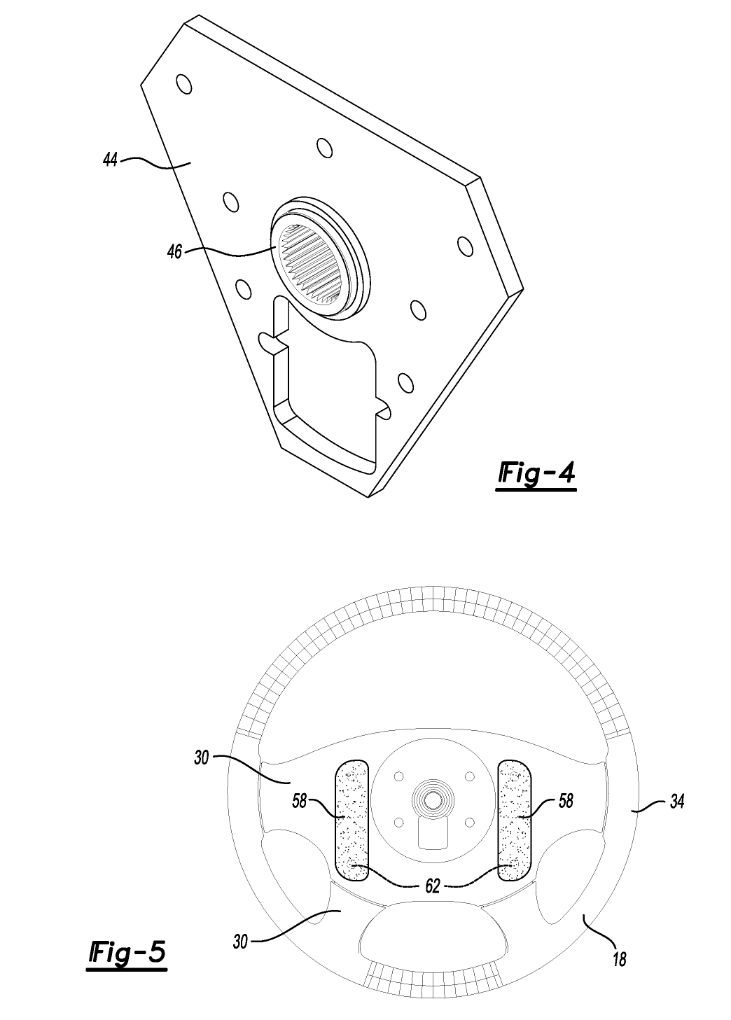

The bottom of the airbag module mounting space 26 includes a hub plate assembly 44 having a hub 46, as shown in FIGS. 2-4. The hub plate assembly 44 is overmolded with the lower portion 18 to secure the hub plate assembly 44 within the lower portion 18. The hub 46 attaches the hub plate assembly 44 to the steering column in a known manner. The hub plate assembly 44 has a generally truncated triangular profile that fits within a recessed area 50 of the lower portion 18. The recessed area 50 extends approximately between a pair of walls 54 extending downward from the airbag module receiving surfaces 28.

The general shape of the hub plate assembly 44 enhances the connection between the hub plate assembly 44 and the lower portion 18. As an example, the geometries of the example steering wheel assembly 10 prevent relative rotational movement between the hub plate assembly 44 and the lower portion 18.

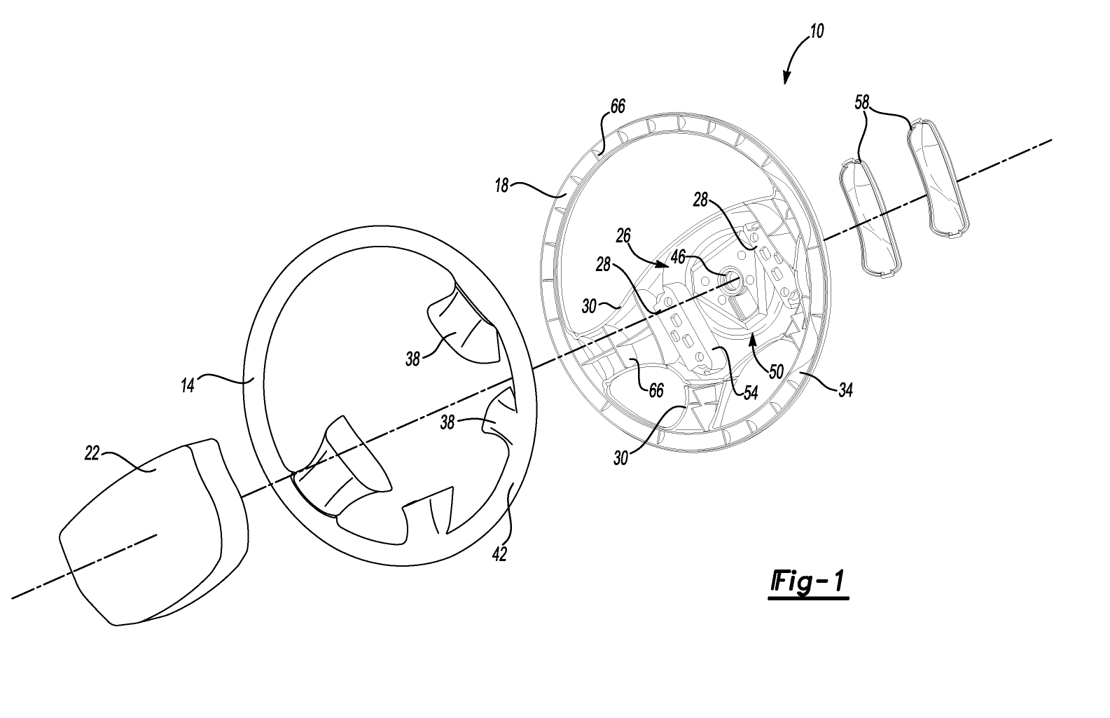

Referring now to FIG. 5, the lower portion 18 accommodates a pair of covers 58. Fasteners (not shown) extend through a plurality of apertures 62 to engage and secure the airbag module 22 (FIG. 1) to the lower portion 18. The covers 58 cover the heads of the fasteners and access pins when the airbag module 22 is in an installed position. In one example, the covers 58 are injection molded in the injection molding tool used for forming the upper portion 14. The removable covers 58 may be molded from a different polymer material than the lower portion 18 and the upper portion 14. The covers 58 typically snap into the lower portion 18 in a known manner.

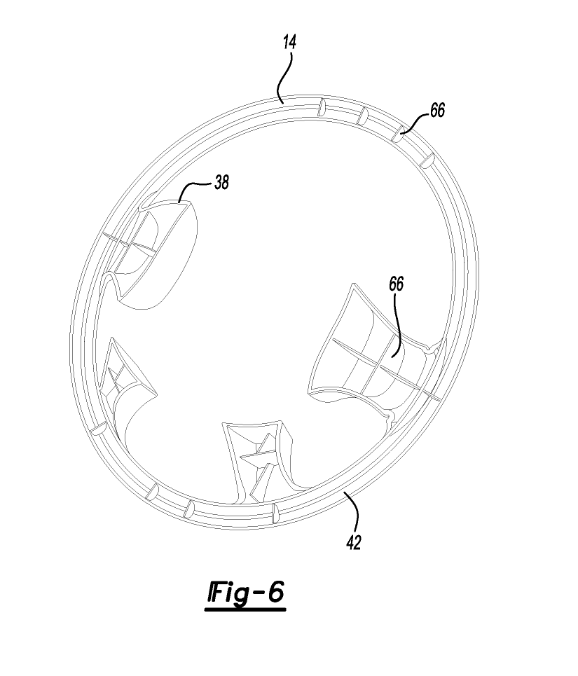

In this example, the upper portion 14 and the lower portion 18 each include a plurality of molded strengthening ribs 66, as shown in FIGS. 1 and 6. Vibration welding the upper rim 42 to the lower rim 34, the upper spokes 38 to the lower spokes 30, and the ribs 66 secures the upper portion 14 relative the lower portion 18. As the steering wheel assembly 10 (FIG. 1) is constructed of a high-strength polymer, no additional reinforcing members of a dissimilar material are needed, which provides a relatively hollow steering wheel assembly 10. Typically, at least the ribs 66 extending from the upper rim 42 and lower rim 34 are aligned radially from the rotational axis.

The upper portion 14 and the lower portion 18 contact each other along a second plane generally perpendicular to the steering column axis and spaced from the first plane defined by the airbag module mounting surfaces 28.

The steering wheel assembly 10 may be leather wrapped or painted. Other examples include finishing the steering wheel assembly 10 with an in-mold film or hydrographic design. The steering wheel assembly 10, when including a recyclable thermo-plastic, provides an eco-friendly design.

Although a preferred embodiment of this invention has been disclosed, a worker of ordinary skill in this art would recognize that certain modifications would come within the scope of this invention. For that reason, the following claims should be studied to determine the true scope and content of this invention.

We claim:

1. A steering wheel assembly, comprising:
an airbag module receiving surface generally defining a first plane;
a lower portion including a lower rim portion and said airbag module receiving surface; and
an upper portion including an upper rim portion secured to said lower rim portion, wherein said upper rim portion and said lower rim portion define a second plane spaced from said first plane.

2. The steering wheel assembly of claim 1, wherein said airbag module receiving surface defines a plurality of apertures for receiving fasteners for securing an airbag module to said airbag module receiving surface.

3. The steering wheel assembly of claim 1, wherein said lower portion includes at least one lower spoke extending between said airbag module receiving surface to said lower rim portion.

4. The steering wheel assembly of claim 3, wherein said upper portion includes at least one upper spoke for covering at least one lower spoke.

5. The steering wheel assembly of claim 4, wherein said at least one upper spoke includes at least two upper spokes and said airbag module receiving surface is positioned between said at least two upper spokes.

6. The steering wheel assembly of claim 1, including ribs extending between said lower rim portion and said upper rim portion.

7. The steering wheel assembly of claim 6, wherein said upper rim portion and said lower rim portion are arranged about an axis and said plurality of ribs are aligned radially relative said axis.

8. The steering wheel assembly of claim 1, wherein said lower portion includes an overmolded hub plate.

9. The steering wheel assembly of claim 8, wherein a hub attaches to said hub plate.

10. The steering wheel assembly of claim 8, wherein a surface of said lower portion transverse said airbag receiving surface limits rotational movement of said hub plate about an axis through said hub.

11. A steering wheel assembly, comprising:
an upper rim portion;
a lower rim portion;
an upper spoke portion integrally molded with said upper rim portion
a lower spoke portion integrally molded with said lower rim portion; and
an airbag module mounting surface integrally molded with the lower spoke portion, wherein said airbag module mounting surface and said upper spoke portion define an airbag module receiving space.

12. The steering wheel assembly of claim 11, wherein said upper rim portion is vibration welded to said lower rim portion.

13. The steering wheel assembly of claim 12, wherein no space defined between said upper rim portion and said lower rim portion includes a support having a dissimilar material.

14. The steering wheel assembly of claim 11, wherein upper spoke portion is vibration welded to said lower spoke portion.

15. The steering wheel assembly of claim 14, wherein a space defined between said upper spoke portion and said lower spoke portion does not include a support having a dissimilar material.

16. The steering wheel assembly of claim 11, wherein said upper rim portion contacts said lower rim portion at a first plane, and said airbag module mounting surface defines a second plane spaced from said first plane.

17. The steering wheel assembly of claim 11, including a hub plate overmolded adjacent said airbag receiving surface.

18. The steering wheel assembly of claim 17, wherein a surface of said lower portion transverse said airbag receiving surface limits rotational movement of said hub plate about an axis through said hub.

19. A polymer steering wheel assembly, comprising:
a base portion;
a plurality of spokes extending from said base; and
a hub plate overmolded within said base portion, said hub plate adapted to connect to a vehicle steering column and having a truncated triangular profile.

20. The steering wheel assembly of claim 19, including a rim, said plurality of spokes extending from said base portion to said rim.

21. The steering wheel assembly of claim 19, including a hub for connecting said hub plate to said vehicle steering column.

22. A method of assembling a steering wheel, comprising:
a) molding an upper rim portion together with an upper spoke portion;
b) molding a lower rim portion together with a lower spoke portion and an airbag module mounting surface; and
c) welding the upper rim portion to the lower rim portion.

23. The method of claim 22, wherein at least one of the upper rim portion and the lower rim portion includes ribs extending to the other of the upper rim portion and the lower rim portion.

24. The method of claim 22, wherein said step c) includes welding the upper rim portion to the lower rim portion at the ribs.

25. The method of claim 22, including providing an airbag module support area for securing an airbag module to the lower rim portion.

26. The method of claim 25, including overmolding a hub plate within the airbag module support area.

27. The method of claim 26, wherein the hub plate attaches to a hub.
